(19) United States
(12) Patent Application Publication
(10) Pub. No.: US 2005/0201922 A1
(43) Pub. Date: Sep. 15, 2005

(54) Addition of salt to depress pH in the generation of chlorine dioxide

(76) Inventors: Keith Kennedy, Lebanon, OH (US); Charles Crawford, Racine, WI (US); Richard L. Sampson, Fair Oaks Ranch, TX (US); Allison H. Sampson, Fair Oaks Ranch, TX (US)

Correspondence Address: JohnsonDiversey, Inc.;8310 16th Street, M/S 509, P.O. Box 902, Sturtevant, WI, 53177-0902, US

(21) Appl. No.: 11/018,433

(22) Filed: Dec. 17, 2004

Related U.S. Application Data
(60) Provisional application No. 60/481,811, filed on Dec. 18, 2003.

(51) Int. Cl. C01B 11/02

(52) U.S. Cl. 423/477

(57) ABSTRACT

The present invention relates to a chlorine dioxide solution with a lowered pH allowing for the removal of mineral deposits in varying industries and for varying surfaces and systems. The chlorine dioxide solution has a pH lower than 5. A method of preparing and using a chlorine dioxide solution with lowered pH to remove mineral deposit and sanitize is also present.

### CROSS-REFERENCE TO RELATED APPLICATIONS

This application is a non-provisional application of U.S. Ser. No. 60/481,811 filed Dec. 18, 2003.

### STATEMENT REGARDING FEDERALLY SPONSORED RESEARCH OR DEVELOPMENT

None.

### FIELD OF THE INVENTION

The present invention relates to the production of chlorine dioxide and the reduction of the pH to effectively remove mineral deposits.

### BACKGROUND OF THE INVENTION

Mineral deposits are a problem in the industrial area from the food and beverage sectors to the laundry and warewashing sectors.

In U.S. Pat. No. 6,416,645 and No. 6,402,916 there is disclosed a combination of ion exchange and catalysis to rapidly and efficiently convert sodium chlorite to chlorine dioxide. The present invention suppresses the pH of the chlorine dioxide with the addition of salts to the sodium chlorite as it is passed through the ion exchange and catalyst systems, as described in the U.S. Pat. Nos. 6,416,645 and 6,402,916 patents, resulting in the production of the acid of the salt used and chlorine dioxide. All salts will have an effect of reducing the pH of the chlorine dioxide solution. The preferred salt for the reduction of pH are sodium phosphate, sodium sulfate, sodium nitrate and sodium acetate.

A wide variety of products exist on the market that are used in various markets to eliminate mineral deposits. These products work in a satisfactory manner but have a wide range of limitations including being harsh to the surfaces with the deposits, hazardous to the individuals or the environment or are unstable which limits shelf life. The typical mineral deposit remover also requires the use of a separate sanitizer to complete the washing of a system.

The ability to have a mineral deposit remover that is safe to use with various systems and processes and is produced in a safe and effective manner is advantageous because it allows for a simpler cleaning process that allows a greater efficient when running equipment. A mineral deposit remover's ability to be used also as a sanitizer in varied systems and under varied conditions will simplify the cleaning process because it will allow for the sanitizing of a system while also removing any mineral deposits reducing the need for separate steps to achieve both a mineral deposit removal and sanitizing process.

### SUMMARY OF THE INVENTION

The present invention allows for a method for producing use of chlorine dioxide as a mineral deposit remover and sanitizer. The ability to work effectively removing mineral deposits while simultaneously sanitizing a system allows for a simplified under a wider range of conditions and eliminates the needs for additional equipment or additional steps in the cleaning process. The invention provides a process where chlorine dioxide has a reduced pH and becomes an effective mineral deposit remover while still effectively sanitizing a system. The invention uses the addition of salts into the process of U.S. Pat. Nos. 6,416,645 and 6,402,916 to reduce the pH of the chlorine dioxide to 5 or less allowing for its use with mineral deposits. The chlorine dioxide in its most preferred state would be below a pH of 3 to remove mineral deposits. The chlorine dioxide with a lower pH allows for the reduction of such mineral deposits commonly found such as carbonates, phosphates, etc. that are commonly encountered in beerstone and milkstone, etc.

5 ZClO₂+MX passed through a resin bed where the 5 Z⁺ is lost and (5+n)H⁺ are gained to produce 5 HClO₂+HₙX then passed through the catalyst to produce 4 ClO₂+Cl⁻+HₙX+2H₂O where Z is any alkali metal, n subscript is equal to the valence of X, M is the cation from the salt solution and X is the anion from the salt solution.

The present invention provides a method for reducing mineral deposits using chlorine dioxide with a reduced pH while retaining the full sanitizing abilities of chlorine dioxide.

### DETAILED DESCRIPTION OF THE INVENTION

A method for producing a composition of low pH chlorine dioxide solution wherein a chlorite solution and a salt solution are passed through an ion exchange resin to convert the chlorite to its acid form and the acid of the salt, which is then passed through a catalyst which produces chlorine dioxide solution with a low pH. The chlorine dioxide solution having a pH of 5 or less and more preferably the chlorine dioxide solution has a pH below 3.

Preferably, a chlorite solution and a salt solution are passed through a cation exchange resin forming chlorous acid and the acid form of the salt solution then both are passed through a metal based catalyst to form a chlorine dioxide solution with a low pH including chlorine ions, water and the acid form of the salt solution.

The chlorite solution is an alkali metal chlorite most preferably sodium chlorite. However, it could be any ionic compounds such as monovalent, divalent, trivalent, or combinations thereof, which will exchange the cation for the hydrogen ion in the resin. The salt solution may be a sodium salt preferably a sodium phosphate or sodium nitrate or sodium sulfate or sodium acetate or any combination thereof. The salt solution is most preferably sodium sulfate.

Also included is a composition for removing mineral deposits employing the chlorine dioxide solution with lowered pH formed as produced by the previously decribed method.

1. A method for producing a composition of low pH chlorine dioxide wherein a chlorite solution and a salt solution are passed through an ion exchange resin and than passed through a catalyst to form a chlorine dioxide solution with a low pH which is applied to a surface or into a system to remove mineral deposits.

2. The method of claim 1 wherein the chlorine dioxide solution is a sanitizer and a mineral deposit remover.

3. The method of claim 1 wherein the chlorine dioxide solution has a pH of 5 or less.

4. The method of claim 1 where in the chlorine dioxide solution has a pH below 3.

5. The method of claim 1 wherein the chlorite solution is sodium chlorite.

6. A method of producing a low pH chlorine dioxides solution wherein a chlorite solution and a salt solution are passed through a cation exchange resin forming chlorous acid and the acid form of the salt solution then both are passed through a metal based catalyst to form a chlorine dioxide solution with a low pH including chlorine ions, water and the acid form of the salt solution.

7. A composition of low pH chlorine dioxide solution as produced by the process of claim 1.
